(19) United States
(12) Patent Application Publication
(10) Pub. No.: US 2008/0306789 A1
(43) Pub. Date: Dec. 11, 2008

(54) System and Method for Generating Revenues in a Retail Commodity Network

(75) Inventors: Robert M. Fell, Summerland, CA (US); Scott Painter, Bel Air, CA (US); Michael R. Bonsignore, Seattle, WA (US); Brian P. Reed, Southlake, TX (US); Gary A. Magnuson, Corpus Christi, TX (US); Thomas D. Gros, Houston, TX (US)

Correspondence Address: SPRINKLE IP LAW GROUP, 1301 W. 25TH STREET, SUITE 408, AUSTIN, TX, 78705, US

(73) Assignee: Pricelock, Inc., Irving, TX (US)

(21) Appl. No.: 12/030,073

(22) Filed: Feb. 12, 2008

Related U.S. Application Data
(60) Provisional application No. 60/900,846, filed on Feb. 12, 2007.
(60) Provisional application No. 60/966,564, filed on Aug. 29, 2007.

(51) Int. Cl. G06Q 10/00; G06Q 50/00

(52) U.S. Cl. 705/7

(57) ABSTRACT

Embodiments disclosed herein provide viable revenue models for a service provider that offers price protection on a retail commodity to businesses as well as individual consumers in a retail commodity network. Specifically, embodiments disclosed offer a plurality of revenue flows in which the cost incurred by a service provider to offer hedge positions associated with a retail commodity can be offset in a variety of ways to cover the operating expenses and generate realistic profits. In some embodiments, a revenue model for a service provider in a retail commodity network may be built depending upon whether hedging cost information is generated internally or obtained externally. Such cost may be passed on to a customer entirely, none at all, or somewhere in between. Embodiments disclosed herein further provide a plurality of revenue sources and ways to generate revenues therefrom.

### CROSS-REFERENCE TO RELATED APPLICATIONS

This application claims priority from Provisional Patent Application No. 60/900,846, filed Feb. 12, 2007, entitled “SYSTEM AND METHOD FOR GENERATING REVENUES IN A RETAIL COMMODITY NETWORK,” No. 60/966,564, filed Aug. 29, 2007, entitled “SYSTEM AND METHOD FOR GENERATING REVENUES IN A RETAIL COMMODITY NETWORK,” the entire contents of which are hereby expressly incorporated herein by reference for all purposes. This application relates to U.S. patent application Ser. No. 11/705,571, filed Feb. 12, 2007, entitled “METHOD AND SYSTEM FOR PROVIDING PRICE PROTECTION FOR COMMODITY PURCHASING THROUGH PRICE PROTECTION CONTRACTS” and Provisional Patent Application No. 60/922,427, filed Apr. 9, 2007, entitled “SYSTEM AND METHOD FOR INDEX BASED SETTLEMENT UNDER PRICE PROTECTION,” which are incorporated herein by reference as if set forth in full.

### FIELD OF THE INVENTION

The present invention relates generally to revenue models. More particularly, the present invention relates to revenue models that offer a variety of ways to offset the cost and expenses of hedging a retail commodity and generate profits.

### BACKGROUND

The term “revenue” generally refers to a company's income and the term “revenue model” generally refers to the way that a company makes money through a variety of revenue flows. A revenue model can be a part of a company's business model. The term “business model” represents a broad range of informal and formal models used by businesses to express their particular business logic in various aspects, including offerings, strategies, infrastructure, operational processes, policies, and finances. For a business, finding ways to generate profitable and sustainable revenue streams can be crucial to its survival and success. In this context, some view business model design as distinct from business modeling, referring the former to defining the business logic of a company at the strategic level and the latter to business process design at the operational level.

The term “business model design” refers to the activity of designing a company's business model, which, as mentioned above, includes a revenue model. Business model design thus includes the designing, modeling and description of a company's revenue model. While a business model design template may facilitate the process of designing and describing a company's revenue model, currently few revenue models are suitable for service providers in a complex and rapidly evolving marketplace such as a retail commodity network.

### SUMMARY OF THE INVENTION

Embodiments disclosed herein provide viable revenue models for a service provider that offers price protection on a retail commodity to businesses as well as individual consumers in a retail commodity network. Specifically, embodiments disclosed offer a plurality of revenue flows in which the cost incurred by a service provider to offer hedge positions associated with a retail commodity can be offset in a variety of ways to cover the operating expenses and generate realistic profits.

In some embodiments, a revenue model for a service provider in a retail commodity network may be built depending upon whether hedging cost information is generated internally or obtained externally. Specifically, the hedging cost information may be generated internally in embodiments where the service provider warehouses the risk associated with offering hedge positions and lays off the risk directly on an open market. In some embodiments, this is referred to as the self-insured model. In embodiments where the service provider does not warehouse the risk, the hedging cost information may be obtained from a hedging partner. In some embodiments, this is referred to as the partner-insured model. In some embodiments, a hybrid model may be utilized in which the hedging partner would insure the risk of settling the protected price of a retail commodity against a national index price on a particular day in a particular locale and the service provider would self-insure the additional risk of settling the protected price of the retail commodity against the actual retail price on the same day in the same locale where the actual retail price is higher than the national index price.

In some embodiments, the service provider may pass on the entire hedging cost to a customer. In some embodiments, the service provider may pass on some hedging cost to a customer. In some embodiments, the service provider may not pass on any hedging cost to a customer. In some embodiments, a customer is an entity. In some embodiments, a customer is an end consumer.

Embodiments disclosed herein further provide a plurality of revenue sources through which a service provider in a retail commodity network can generate profit over the hedging cost and operating expenses. Examples of the plurality of revenue sources include, but not limited to, annual membership fees, interest earning on advances, spreads between various prices, affinity retailer discounts, insurance premium, advertising, cross-selling of related products, proprietary data sales and licensing, technology and intellectual property licensing fees, financial information products, consulting fees, management fees, intra-contract liquidity, broker fees, marketing rebates, organized reverse Dutch market auction, etc.

In some embodiments, there can be several types of spreads: a spread between the service provider's lock price and actual retail price, a spread between the hedging partner's strike price and the service provider's lock price; and a spread between the hedging partner's index price and the service provider's index price, which may be referred to as an “intra-index spread.”

These, and other, aspects will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the disclosure, and the disclosure includes all such substitutions, modifications, additions or rearrangements.

### BRIEF DESCRIPTION OF THE DRAWINGS

A more complete understanding of the disclosure and the advantages thereof may be acquired by referring to the following description, taken in conjunction with the accompanying drawings in which like reference numbers generally indicate like features and wherein:

FIG. 1 depicts a block diagram showing exemplary embodiments in which hedging cost information may be generated or obtained.

FIG. 2 depicts a flow chart representing one embodiment of a revenue generation process in a retail commodity network.

FIG. 3 depicts a plot diagram illustrating one embodiment of a revenue model.

### DETAILED DESCRIPTION

The disclosure and the various features and advantageous details thereof are explained more fully with reference to the non-limiting embodiments that are illustrated in the accompanying drawings and detailed in the following description. Descriptions of well known starting materials, processing techniques, components and equipment are omitted so as not to unnecessarily obscure the disclosure in detail. Skilled artisans should understand, however, that the detailed description and the specific examples, while disclosing preferred embodiments, are given by way of illustration only and not by way of limitation. Various substitutions, modifications, additions or rearrangements within the scope of the underlying inventive concept(s) will become apparent to those skilled in the art after reading this disclosure.

Before discussing specific embodiments, an exemplary hardware architecture for implementing embodiments of the present invention will now be described. Specifically, one embodiment of the present invention can include a computer communicatively coupled to a network (e.g., the Internet). As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (e.g., mouse, trackball, stylist, etc.), or the like. In embodiments of the invention, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (e.g., a HD). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of complied C++, Java, HTML, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like.

Within this disclosure, the term “commodity” refers to an article of commerce—an item that can be bought and sold freely on a market. It may be a product which trades on a commodity exchange or spot market and which may fall into one of several categories, including energy, food, grains, and metals. Currently, commodities that can be traded on a commodity exchange include, but are not limited to, crude oil, light crude oil, natural gas, heating oil, gasoline, propane, ethanol, electricity, uranium, lean hogs, pork bellies, live cattle, feeder cattle, wheat, corn, soybeans, oats, rice, cocoa, coffee, cotton, sugar, gold, silver, platinum, copper, lead, zinc, tin, aluminum, titanium, nickel, steel, rubber, wool, polypropylene, and so on. Note that a commodity can refer to tangible things as well as more ephemeral products. Foreign currencies and financial indexes are examples of the latter. For example, positions in the Goldman Sachs Commodity Index (GSCI) and the Reuters Jefferies Consumer Research Board Index (RJCRB Index) can be traded as a commodity. What matters is that something be exchanged for the thing. New York Mercantile Exchange (NYMEX) and Chicago Mercantile Exchange (CME) are examples of a commodity exchange. Other commodities exchanges also exist and are known to those skilled in the art.

In a simplified sense, commodities are goods or products with relative homogeneousness that have value and that are produced in large quantities by many different producers; the goods or products from each different producer are considered equivalent. Commoditization occurs as a goods or products market loses differentiation across its supply base. As such, items that used to carry premium margins for market participants have become commodities, of which crude oil is an example. However, a commodity generally has a definable quality or meets a standard so that all parties trading in the market will know what is being traded. In the case of crude oil, each of the hundreds of grades of fuel oil may be defined. For example, West Texas Intermediate (WTI), North Sea Brent Crude, etc. refer to grades of crude oil that meet selected standards such as sulfur content, specific gravity, etc., so that all parties involved in trading crude oil know the qualities of the crude oil being traded. Motor fuels such as gasoline represent examples of energy-related commodities that may meet standardized definitions. Thus, gasoline with an octane grade of 87 may be a commodity and gasoline with an octane grade of 93 may also be a commodity, and they may demand different prices because the two are not identical—even though they may be related. Those skilled in the art will appreciate that other commodities may have other ways to define a quality. Other energy-related commodities that may have a definable quality or that meet a standard include, but are not limited to, diesel fuel, heating oils, aviation fuel, and emission credits. Diesel fuels may generally be classified according to seven grades based in part on sulfur content, emission credits may be classified based on sulfur or carbon content, etc.

Historically, risk is the reason exchange trading of commodities began. For example, because a farmer does not know what the selling price will be for his crop, he risks the margin between the cost of producing the crop and the price he achieves in the market. In some cases, investors can buy or sell commodities in bulk through futures contracts. The price of a commodity is subject to supply and demand.

A commodity may refer to a retail commodity that can be purchased by a consuming public and not necessarily the wholesale market only. One skilled in the art will recognize that embodiments disclosed herein may provide means and mechanisms through which commodities that currently can only be traded on the wholesale level may be made available to retail level for retail consumption by the public. One way to achieve this is to bring technologies that were once the private reserves of the major trading houses and global energy firms down to the consumer level and provide tools that are applicable and useful to the retail consumer so they can mitigate and/or manage their measurable risks involved in buying/selling their commodities. One example of an energy related retail commodity is motor fuels, which may include various grades of gasoline. For example, motor fuels may include 87 octane grade gasoline, 93 octane grade gasoline, etc as well as various grades of diesel fuels. Other examples of an energy related retail commodity could be jet fuel, heating oils, electricity or emission credits such as carbon offsets. Other retail commodities are possible and/or anticipated.

While a retail commodity and a wholesale commodity may refer to the same underlying good, they are associated with risks that can be measured and handled differently. One reason is that, while wholesale commodities generally involve sales of large quantities, retail commodities may involve much smaller transaction volumes and relate much more closely to how and where a good is consumed. The risks associated with a retail commodity therefore may be affected by local supply and demand and perhaps different factors. Within the context of this disclosure, there is a definable relationship between a retail commodity and the exposure of risks to the consumer. This retail level of the exposure of risks may correlate to the size and the specificity of the transaction in which the retail commodity is traded. Other factors may include the granularity of the geographic market where the transaction takes place, and so on. Within this disclosure, a geographic boundary may be defined as a city, a borough, a county, a state, a country, a region, a zip code, or other predetermined area, or may be arbitrarily defined as a designated market area (DMA), or some combination or division. For example, the demand for heating oil No. 2 in January may be significantly different in the Boston market than in the Miami market.

Pricing a retail commodity can be a very difficult process, particularly if that retail commodity tends to fluctuate in an unpredictable manner. Take gasoline as an example, as the price of oil continues to fluctuate globally and fluidly, fuel prices at the pump can change from location to location on a daily or even hourly basis. In such a volatile, complex, and dynamically evolving market, it can be extremely difficult for a service provider to provide price protection products on the retail commodity in a sustainable and profitable manner.

Embodiments disclosed herein provide viable revenue models for a service provider that offers price protection on a retail commodity to businesses as well as individual consumers in a retail commodity network. Embodiments disclosed herein can be readily implemented or adapted by just about any price protection system which offers price protection on retail commodities. Examples of such price protection systems can be found in U.S. patent application Ser. No. 11/705,571, filed Feb. 12, 2007, entitled “METHOD AND SYSTEM FOR PROVIDING PRICE PROTECTION FOR COMMODITY PURCHASING THROUGH PRICE PROTECTION CONTRACTS” and Provisional Application No. 60/922,427, filed Apr. 9, 2007, entitled “SYSTEM AND METHOD FOR INDEX BASED SETTLEMENT UNDER PRICE PROTECTION,” both of which are incorporated herein by reference as if set forth in full.

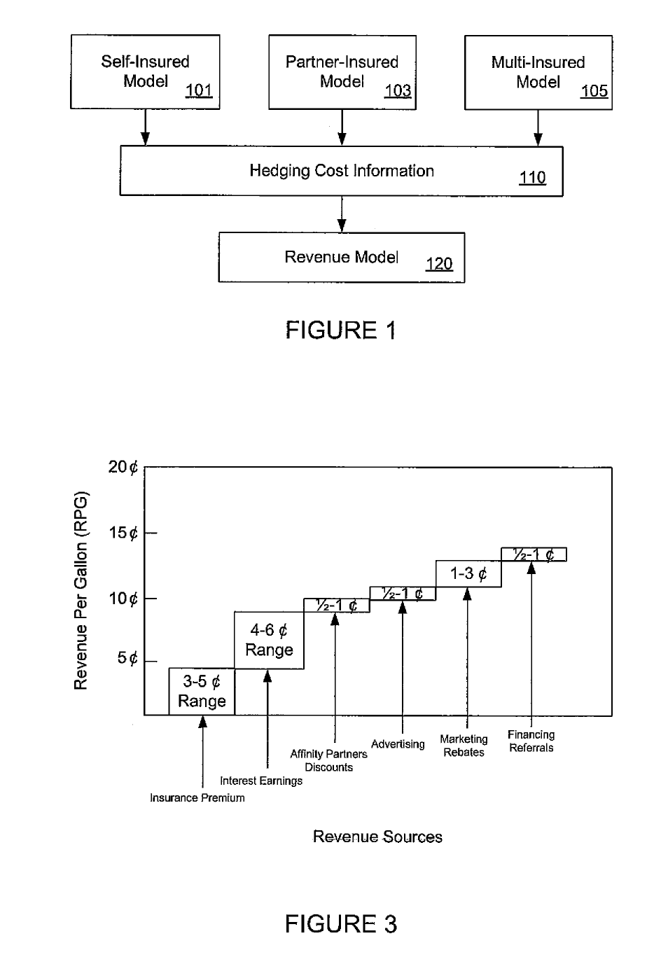

FIG. 1 depicts a block diagram showing exemplary embodiments in which hedging cost information may be generated or obtained by an entity capable of providing price protection products and services on one or more retail commodities. In some embodiments, this entity may be referred to as a service provider. Embodiments disclosed offer a plurality of revenue flows in which the cost incurred by a service provider to offer hedge positions associated with a retail commodity can be offset in a variety of ways to cover the operating expenses and generate realistic profits.

In some embodiments, a revenue model for a service provider in a retail commodity network may be built depending upon whether hedging cost information is generated internally or obtained externally. In embodiments implementing self-insured model 101, the service provider may warehouse and manage the risk associated with offering hedge positions. In some embodiments, the service provider may lay off the risk directly on an open market, on a wholesale basis. In embodiments implementing self-insured model 101, the service provider can determine hedging cost information 110 internally as input to revenue model 120. In embodiments implementing partner-insured model 103, the service provider may not warehouse the risk and may obtain hedging cost information 110 from a hedging partner. In embodiments implementing multi-insured model 105, the hedging partner would insure the risk of settling the protected price of a retail commodity against a national index price on a particular day in a particular locale and the service provider would self-insure the additional risk of settling the protected price of the retail commodity against the actual retail price on the same day in the same locale where the actual retail price is higher than the national index price. For detailed teachings on index based settlement under price protection, readers are directed to Provisional Application No. 60/922,427, filed Apr. 9, 2007, entitled “SYSTEM AND METHOD FOR INDEX BASED SETTLEMENT UNDER PRICE PROTECTION,” which is incorporated herein by reference.

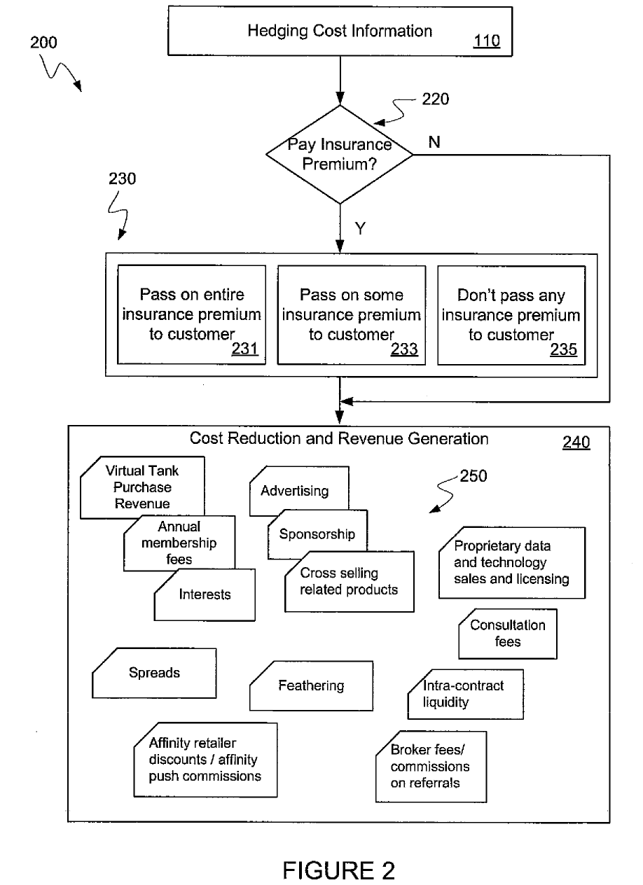

FIG. 2 depicts a flow chart representing one embodiment of revenue generation process 200 in a retail commodity network. In some embodiments, revenue generation process 200 can be implemented by a commercial entity which provides price protection products and services for a retail commodity. In some embodiments, such a commercial entity is referred to as a service provider. In some embodiments, with hedging cost information 110 from FIG. 1, an algorithm, being embodied on one or more computer-readable storage media carrying computer-executable program instructions implementing one embodiment of revenue generation process 200 in a retail commodity network, may operate to determine at step 220 whether to pay an insurance premium and to whom, based on information that may be pre-defined or provided by a user in real time. As one skilled in the art can appreciate, such payments can be made in various ways, including electronic transactions over the Internet.

In some embodiments, revenue generation process 200 may proceed to step 240 in cases where the service provider does not pay any insurance premium to a hedging partner. In some embodiments, revenue generation process 200 may proceed to step 230 in cases where a hedging partner charges an insurance premium for laying off some or all of the risk associated with hedging against the forward retail price of a commodity. Such a hedging partner can be any financial institution or enterprise capable of laying off such risk on an open market.

In some embodiments, hedging cost information 110 may contain a matrix of strike prices determined by a hedging partner. The strike prices may correspond to the prices per unit of the commodity at which the hedging partner has the right to buy the commodity via a security such as an option on the commodity. In some embodiments, hedging cost information 110 may contain a matrix of strike prices determined by the hedging partner and a matrix of insurance prices (insurance premium) corresponding to those strike prices. In some embodiments, the insurance premium represents the hedge cost per gallon (HCPG) determined by the hedging partner. HCPG is the cost per gallon for the hedging partner to insure against the risk of the service provider's consumers depleting their virtual gas tanks when retail prices exceed their protected price, sometimes referred to as the “lock price”. In such cases, the service provider may purchase the insurance on behalf of its customers. The lock prices are determined by the service provider based on the strike prices. The lock prices can be the same or different from strike prices. For detailed teachings on how lock prices can be created, readers are directed to U.S. patent application Ser. No. 11/705,571, filed Feb. 12, 2007, entitled “METHOD AND SYSTEM FOR PROVIDING PRICE PROTECTION FOR COMMODITY PURCHASING THROUGH PRICE PROTECTION CONTRACTS,” which is incorporated herein by reference.

Hedging cost information 110 can be in any suitable form/format and are not required to be in the form of matrices. In some embodiments, a strike price matrix can contain a plurality of parameters including strike prices for fuel grade per gallon, sensitivities, location, and duration. In some embodiments, sensitivities may include price tolerance, affinity, etc. In some embodiments, the location parameter may specify a geographic boundary. In some embodiments, the duration parameter may specify a period of time in the future. As a specific example, a strike price matrix may indicate a strike price for $2.50 per gallon for unleaded gasoline in all 4000 counties in the United States for 30 days. An insurance premium matrix may contain the corresponding HCPG for protecting against prices exceeding $2.50 per gallon for unleaded gasoline in all 4000 counties in the United States during the same 30 days.

At step 230, an algorithm, being embodied on one or more computer-readable storage media carrying computer-executable program instructions implementing one embodiment of revenue generation process 200 in a retail commodity network, may operate to perform an analysis based on several factors to determine how much, if any, of the insurance premium is to be passed on to a customer. In some embodiments, a customer is an entity. In some embodiments, a customer is an individual consumer. These factors can include information that may be pre-defined or obtained in real time, as well as information related to consumer price sensitivity and resultant conversion (market driven) and the service provider's ability to absorb this insurance premium by generating revenues in other ways. In some embodiments, these factors can include market conditions such as contango and backwardation. Backwardation describes a market where spot or prompt prices are higher than prices in the future—a downward sloping forward curve. It indicates that prompt demand is high. Contango is the opposite, with future prices higher than spot prices.

In some embodiments, a piece of code 231 may handle passing the entire hedging cost to a customer. In some embodiments, a piece of code 233 may handle passing some hedging cost to a customer. In some embodiments, a piece of code 235 may bypass passing on any hedging cost to a customer. Code 231, 233, and 235 may be implemented in various ways.

At step 240, revenue generation process 200 may engage a plurality of revenue sources 250 through which the service provider can reduce cost and/or generate profit over the hedging cost and operating expenses. Examples of revenue sources 250 can include, but not limited to, the following:

### Virtual Tank Purchase Revenue:

Hedge Premium—this is the insurance cost per gallon for a hedging partner and may be passed onto the consumer entirely. Following the above example, a HCPG may add 20 cents to the cost of a price protection contract in addition to the strike price of $2.50 per gallon for unleaded gasoline in all 4000 counties in the United States for 30 days.

Insurance Premium—this is the insurance premium charged by the service provider. In some embodiments, this can be tacked onto an index price such that a customer would be presented with a higher index price. In some embodiments, this can be tacked onto the HCPG, also referred to as Hedge Premium, charged by the hedging partner. Following the above example, another 5 cents may be added to the cost of a price protection contract where the strike price is $2.50 per gallon for unleaded gasoline in all 4000 counties in the United States for 30 days and the corresponding HCPG is 20 cents per gallon.

### Annual Membership Fees:

Membership fees can be collected based on a cap on the amount of a commodity purchased (maximum approach) or based on minimum amount of the commodity purchased (minimum threshold approach). Membership fees can be paid in advance and are in addition to the pre-paid purchase price of the retail commodity. In the case of gasoline, membership fees can be collected based on a cap or minimum number of gallons purchased.

In some embodiments, there can be at least two types of annual memberships: one for consumers and one for commercial entities. The former type may provide a bundled price protection to individuals or households. Using gasoline as an example, a $120 annual membership fee may provide one year of price protection for a household with two cars that consume 660 gallons of unleaded gasoline a year. The latter type may include a commercial annual portal fee for the privilege of using commercial grade analytical tools, modeling tools, management tools, and so on through a portal provided and maintained by the service provider. Both types of memberships may be implemented in various levels and may incorporate no-hedging related services per level. Examples of non-hedging related services may include, but not limited to, roadside assistance, ambulance service, online information services, etc.

### Interests:

Interest earnings on advances—such advances may refer to any pre-paid purchases of a commodity by a customer. The service provider can earn interest on the advances so long as the virtual reserve of the customer remains positive.

Interest earnings on interchange fees/float—the service provider can also be a card issuer and thus earn interests on funds flowing through a transaction process involving the purchase of a commodity. In the case of buying gasoline with a fuel card issued by the service provide, such a transaction process would begin at the pump and the service provider may earn interest on the purchase amount prior to paying the next recipient in the transaction process.

Interest on spreads—the service provider may also earn interest on various spreads, which are described in more detail below.

### Advertising:

Advertising can be a revenue source for the service provider. One embodiment involves web-based advertising opportunities sold to organizations interested in reaching an aggregated group of consumers with similar psychographic behavior. In one embodiment, the service provider may host a Website or portal having a sales channel, ad spaces, or the like. As an example, one way to determine how much revenue it can generate may comprise the following:

1. On the top level, make an assumption (estimate) on how many customers the service provider may have;
2. Make another assumption (estimate) on their frequency of visit to a Website of the service provider;
3. Multiply 1) and 2) to get the total number of visits to the Website;
4. Make an assumption (estimate) on the number of page views per visit;
5. Multiply 3) and 4) to get the total number of page views, each of which represents the opportunity to serve one or more advertisement to some consumers as the page is generated; and
6. Multiply 5) by an advertising rate (CPM) to determine the estimate revenue of the Website in dollars. CPM or Cost Per Mille, which means cost per thousand, is a commonly used measurement in advertising, including radio, television, newspaper, magazine and online advertising. It is used in marketing as a benchmark to calculate the relative cost of an advertising campaign or an ad message in a given medium. Rather than an absolute cost, CPM estimates the cost per 1000 views of the ad, so it can be purchased on the basis of what it costs to show the ad to one thousand viewers. Below is an example of how CPM can be computed:

Total price for running an ad is $10,000.

The total number of Website visitors is 2,000,000.

CPM=($10,000×1000)/2,000,000=$5.00.

Alternatively, total price=(2,000,000/1000)*$5.00.

### Sponsorship:

Instead of or in addition to advertising, a business entity may decide to sponsor a particular area or section of the service provider's Website or portal. Each such sponsor may pay a fee to occupy a certain real estate on the service provider's Website or portal. For example, sponsor may pay a fee to occupy all the available ad space on the service provider's Website or portal.

### Cross Selling Related or Complementary Services and Products:

Through strategic relationships with other entities, the service provider may cross sell related or complementary services and products to its customers. As a specific example, a price protection contract may be offered as a part of a vehicle purchase program or package.

### Proprietary Data and Technology Sale and Licensing:

Data collected and/or generated as well as technologies created and developed by the service provider may be sold and/or licensed to interested parties. In some embodiments, the service provider may host a Website or portal having a variety of proprietary software tools for providing forward retail price prediction, commodity hedging scenarios, historical data streams, diagnostics, analytics, commodity management services, monitoring services, reporting services, commodity price searching services, etc. and the service provider may charge a fee for using one or more of its proprietary tools. In some embodiments, the service provider may provide the following financial information products:
Trading royalties from the service provider's local fuel price derivative indexes, index-linked securities, and the like.
Index publication licensing revenues.
Data trading analytics sales of fleet fuel consumption behavior impacting derivative valuations.
Sale of proprietary fuel contracting and fuel consumption data streams as an input to macroeconomic and industry sector forecasting

### Consultation Fees:

In some cases, commercial entities may desire to consult the service provider on various issues related to price protection of a commodity. In such cases, the service provider may charge appropriate consultation fees. In some cases, commercial entities may desire to consult the service provider regarding utilizing analytical and commodity management tools provided by the service provider.

### Intra-Contract Liquidity:

In some cases, the service provider may choose to buy out of a risky position by buying back price protection contract(s) prior to expiration. Doing so may reduce the service provider's cost and/or risk.

In some cases, the service provider may choose to purchase a commercial customer's position prior to its expiration. In the case of fuel, such a purchase may occur before the commercial customer's virtual tank is depleted. This is also referred to as “option repurchase.”

### Broker Fees/Commissions on Referrals:

In some cases, the service provider may earn points and/or rebates provided by banks, financing partners, and other lenders who contract directly with consumers to finance pre-purchases of a commodity. In the case of fuel, consumers may pre-purchase fuel through the use of credit cards. This is separate from the interest earned on pre-purchase advances. In partnering with a financial institution to issue cards, the return could be in the form of referral fees, percentage of outstanding balance fees, percentage of interchange fees, or the like.

### Spreads:

In some embodiments, there can be several types of spreads: a spread between the service provider's lock price and actual retail price, a spread between the hedging partner's strike price and the service provider's lock price; and a spread between the hedging partner's index price and the service provider's index price, which may be referred to as an “intra-index spread.”

As an example, suppose that the hedging partner's index price is $2.50 per gallon of gasoline and the service provider's index price is $2.60 per gallon of gasoline. When the retail market price reaches $3.00 per gallon of gasoline, a customer decides to exercise his or her option. In this case, the transaction is settled not at the pump but against the service provider's index price, which is $2.60. The service provider thus files a claim with the hedging partner, which pays the service provider 50 cents (i.e., the difference between the retail price of $3.00 and the hedging partner's index price of $2.50). The service provider pays the customer 40 cents (i.e., the difference between the retail price of $3.00 and the service provider's index price of $2.60), gaining a 10 cents intra-index spread.

Another type of spread is a spread between the index price and the retail price, which may be referred to as an “index spread.” As an example, suppose the index price is $2.00 per gallon of gasoline at Day One when a customer purchases a price protection product from the service provider (i.e., the customer is protected at $2.00). At Day 15 the index price goes up to $2.50 and the customer who is protected at $2 purchases gas at a pump. The retail price at the pump is $2.25. In this case, the customer exercises and the service provider pays 25 cents, which is the difference between the index price of $2.00 at Day One and the retail price of $2.25 at Day 15. However, since the customer exercises below the index price at Day 15, there is a 25 cents economical benefit which the service provider can choose to pass through all, some, or none to the customer.

More detailed teachings on the index based settlement under price protection contracts and examples thereof can be found in Provisional Application No. 60/922,427, filed Apr. 9, 2007, entitled “SYSTEM AND METHOD FOR INDEX BASED SETTLEMENT UNDER PRICE PROTECTION,” which is incorporated herein by reference. These and other potential spreads can be used to generate further revenues by investment and/or savings.

### Feathering:

In some embodiments, the commodity price protection products can have financially sophisticated structures tailored to specific insurance needs. Some embodiments may offer gradually increased commodity price protection coverage up to a certain point over a period of time. Some embodiments may offer gradually decreased insurance cost down to a certain amount over a period of time. The point at which the price protection takes effect may differ from one commodity price protection product to another. Instead of one discrete contract price, some embodiments may implement a range of strike prices, each corresponding to a certain percentage of commodity price protection coverage. For example, suppose the commodity is a type of motor fuel, a first strike price may be $3.00 per gallon and offers only 25% of coverage, a second strike price may be $3.20 per gallon and offers 50% of coverage, a third strike price may be $3.50 per gallon and offers 75% of coverage, and a fourth strike price may be $3.80 per gallon and offers 100% of coverage. In the case of 100% coverage, the price protection customer never has to pay more than $3.80 per gallon for the amount of motor fuel specified in the contract.

By feathering product offerings tailored to specific needs, cheaper price protection can be made available to customers. Feathering product offerings tailored to specific needs may also increase profit margins. Profit margins can be increased because feathering effectively opens up a broader audience who may purchase various types of price protection products. Thus, even if some customers may be charged less, the service provider can still increase profit margins through feathering.

### Affinity Retailer Discounts/Affinity Push Commissions:

In some cases, the service provider may choose to develop strategic relationships with commercial entities, also referred to as affinity partners, carrying a certain commodity. In the case of fuel, the service provider may form strategic relationships with regional owner/operators of multiple-unit gas stations. Such a strategic relationship may be created through partnership, contract, or the like. In exchange for driving, pushing, directing, or otherwise influencing consumers to these stations, affinity partners would provide the service provider with a discount, rebate, and/or commission on their retail markup, also referred to as the cents per gallon markup, from rack rates, also referred to as the rack markup, which refers to the price per grade per gallon paid by the affinity partners to have the fuel delivered to their stations. All or some of this discount, rebate, and/or commission can be passed to the customers to encourage participation.

As an example, the service provider may take $0.01 off of a negotiated $0.05 per gallon discount provided by an affinity retailer and pass it to a customer. Alternatively, the service provider may take an affinity retailer discount as profit. Because the retail locations are known at the time of purchase, these affinity relationships can be priced up front to the customers in their lock price per gallon, as a discount or rebate after the pump transaction, or a combination of both.

The service provider may push customers to preferred stations or a network of preferred retail stations that are not necessarily affinity partners. This network of preferred retail stations can be a dynamic, constantly changing group of the lowest price stations within a specified geographic boundary. Based on both spotted and actual transactional data, the service provider can determine and communicate such preferred retail stations for its customers. Suitable communication channels may include, but not limited to, the service provider's Website, instant messaging, emails, real time data feed to global positioning system-enabled devices, mobile devices, personal computing devices, etc. The service provider can generate revenues indirectly through cost reduction due to the arbitrage between the insurance paid, which is based on the combined high and low priced stations within the specified geographic boundary, and the reduced cost of fuel for consumers going to low price stations. Thus, in aggregate, the service provider can get “cheaper insurance” from the hedging partner based on actual consumer behavior.

FIG. 3 depicts a plot diagram illustrating one embodiment of a revenue model which, in this example, generates revenues from several revenue sources including insurance premium, interest earnings, affinity partners discounts, advertising, marketing rebates, and financing referrals. In this example, each of these revenue sources may generate income ranging from half a cent to 6 cents and the total net revenue per gallon therefore ranges from 9.5 cents to 17 cents per gallon. Based on these values, a conservative estimate may yield the total net revenue of 14 cents per gallon (CPG) which includes 4 CPG from insurance premium, 5 CPG from interest earnings, 1 CPG from affinity partners discounts, 1 CPG from advertising, 2 CPG from marketing rebates, and 1 CPG from financing referrals. A skilled artisan will appreciate that the number and types of revenue sources are shown in FIG. 3 as examples only and are not to be construed as limiting in anyway. Similarly, the range of revenues which may be generated through revenue sources shown in FIG. 3 and the total net revenue per gallon thus generated are to be construed as exemplary and non-limiting.

Below exemplifies how, in one embodiment, a revenue model disclosed herein may be applied to generate revenues for a commodity price protection provider (Price lock).

Suppose Pricelock offers a customer forward price protection on the retail price of gasoline with the following array:
1. Nationwide delivery.
2. “Lock Price” at a stated contract price in a price deck that contains 4000 prices representing the relative price of gas in 4000 counties across the United States. Assume that, in the county where the customer will buy gas, the stated contract price is $2.00 per gallon of gas, which includes a small premium of 10 cents per gallon of gas in addition to prevailing retail pump price, which is $1.90 per gallon of gas on lock (contract) date.
3. Suppose that the customer buys 100 gallons of gas at the lock price with the right to take delivery anytime over the next 12 months.
4. In the financial transaction with Pricelock, the customer goes on the Pricelock web site and charge $200 on a credit card via the Pricelock web site.
5. $200 flows to Pricelock which deposits such funds in a trust account managed by a fiduciary.
6. As part of the contract, the customer pays a membership fee, say, $45 annually, in cash to Pricelock which entitles the customer to lock up to a certain amount, say, 1000 gallons, of gasoline. If the customer is a commercial customer, they may pay a per gallon “Lock Fee,” say, 20 cents per gallon or, in this case, $20 for 100 gallons of gas.
7. Suppose that PriceLock offered alternative lock prices to the customer over $2.00, and for each ten cents over $2.00, the per gallon lock fee hypothetically was reduced by 2 cents. So, in this case, $220 was charged to the credit card of the customer and $200 flowed through as an “advance” to a trust account as mentioned above and $20 was PriceLock revenue.
8. Pricelock then enters into a “Basis Risk Sales Contract” with a financial institution (a hedging partner) whereby the hedging partner assumes the basis risk for the upward price movement of gas for one year. Suppose the hedging partner charges Pricelock 15 cents per gallon or $15.00 for 100 gallons of gas to assume this risk. In this case, Pricelock earned a $5 gross margin as “Insurance Mark-up.
9. Suppose that the customer holds the position for exactly one day less than one year and on that date the customer purchases 50 gallons of gas at a preferred location or an affinity Pricelock partner for $3.00 per gallon of gas and 50 gallons of gas at a non-preferred or non-affinity location for $3.00 per gallon of gas. As part of the contract, the Pricelock customer gets a 2-cent per gallon rebate to a virtual Pricelock gas purchase reserve for use in the subsequent purchase of gasoline only through the Pricelock program. Assume that Pricelock has a 5 cent per gallon retail price discount with all affinity and preferred vendors. At the time of those two transactions, the following economic transactions occur.
   a. Non-Affinity Station 1
   i. $150 dollars is charged through the pump system on the Pricelock card and Pricelock remits $150 to the credit card clearing company which then is paid by the clearing company to the retailer. This is cost of goods sold for Pricelock.
   ii. The consumer's virtual cash purchase reserve is charged for $100 (50 gallons at $2.00 per gallon). This cash moves from the trust account and is then gross revenue for Pricelock.
   iii. Pricelock then informs the hedging partner of the transaction and the hedging partner remits to Pricelock the cash differential between the retail price ($3.00) and the contract strike price ($2.00) for the amount of gas purchased (50 gallons). In this case, the hedging partner remits $1×50=$50 to Pricelock.
      b. Affinity Station 2
   i. $150 dollars (at retail) is charged through the pump system on the Pricelock card and Pricelock remits $147.50 to the credit card clearing company which then is paid by the clearing company to the retailer. This is gross cost of goods sold for Pricelock. The contractual affinity discount to the retailer in this case is 5 cents per gallon or $2.50 for 50 gallons of gas purchased.
   ii. The consumer's virtual cash purchase reserve is charged for $100 (50 gallons at $2.00 per gallon). This cash moves from the trust account and is then gross revenue for Pricelock.
   iii. Pricelock also provides a credit or affinity rebate of $1 (50 gallons at 2 cents per gallon) to the virtual on-line tank of the customer good for future Pricelock purchases.
   iv. Pricelock then informs the hedging partner of the transaction and the hedging partner remits to Pricelock the cash differential between the net retail price, which, in this case, is $2.85 ($3.00 less 5% affinity discount), and the contract strike price ($2.00) for the amount of gas purchased (50 gallons). In this case, the hedging partner remits ($2.85-$2.00)×50=$42.50 to Pricelock.

Note that in the above example it is assumed that the hedging partner priced the hedge within the basis risk environment where an affinity program discount may be utilized. In cases where the hedging partner may hedge to retail, Pricelock may keep 100% of the value of the push. In some cases, Priclock may reflect the push into basis risk to reduce the net hedging costs, strumming the likely elasticity of the market while minimizing the insurance costs.

Additionally, Pricelock may have other sources of revenue from the customer relationship including:
$10 customer monetization revenue from the advertising revenue and cross selling programs to the customer;
Interest on the deposit=5% on $200 for one year=$10; and
On transactional floats, Pricelock earned another $0.50 in interest revenue.

Suppose that, on day 364, this customer approached Pricelock and instead of buying gas, because they had no current physical need for gas, they wanted to unwind their contract with us. On that day, the customer's synthetic call option is worth $100 (prevailing retail price of $3.00 per gallon−strike price of $2.00 per gallon for 100 gallons of gas). Suppose that Pricelock has a contract novation program where contract positions are purchased at all times at half of the then prevailing value. In this case, Pricelock may remit the customer's $200 deposit from the trust and $50 dollars in contract settlement. In turn, the hedging partner remits to Pricelock $75 in insurance related to the contract and Pricelock thus earns a $25 profit margin under this scenario.

In the foregoing specification, the invention has been described with reference to specific embodiments. However, one of ordinary skill in the art will appreciate that various modifications and changes can be made without departing from the spirit and scope of the invention disclosed herein. Accordingly, the specification and figures disclosed herein are to be regarded in an illustrative rather than a restrictive sense, and all such modifications are intended to be included within the scope of the disclosure as defined in the following claims and their legal equivalents.

We claim:

1. A method for generating revenues in a retail commodity network, comprising:
generating or obtaining hedge cost information as input to a revenue model, wherein the hedge cost information includes costs associated with hedging a commodity on a wholesale basis;
determining whether to pass none, some, or all of the costs to a customer, wherein the customer is an individual user or a commercial entity;
engaging one or more revenue sources specified in the revenue model; and
aggregating a total net revenue per unit of the commodity from the one or more revenue sources.

2. The method of claim 1, wherein the commodity is gasoline.

3. The method of claim 2, wherein the hedge cost information contain a matrix of strike prices and a matrix of insurance prices corresponding to the strike prices.

4. The method of claim 3, wherein each of the insurance prices represents a hedge cost per gallon for insuring against a risk of the customer depleting a virtual gas tank of the gasoline when retail prices of the gasoline exceed the customer's lock price.

5. The method of claim 4, further comprising warehousing and managing the risk.

6. The method of claim 5, further comprising laying off the risk on an open market.

7. The method of claim 3, wherein the matrix of strike prices contains a plurality of parameters including strike prices for fuel grade per gallon, sensitivities, location, and duration.

8. The method of claim 3, further comprising determining an amount of the insurance prices to be passed on to the customer.

9. The method of claim 1, further comprising determining a range of strike prices tailored for the customer, wherein each of the strike prices corresponds to a certain percentage of price protection coverage for the commodity.

10. A computer-readable medium carrying program instructions executable by a processor to perform:
generating hedge cost information as input to a revenue model, wherein the hedge cost information includes costs associated with hedging an energy commodity on a wholesale basis and wherein the revenue model specifies one or more revenue sources;
determining whether to pass none, some, or all of the costs to a customer, wherein the customer is an individual user or a commercial entity; and
aggregating a total net revenue per unit of the energy commodity from the one or more revenue sources.

11. The computer-readable medium of claim 10, wherein the energy commodity is fuel.

12. The computer-readable medium of claim 11, wherein the hedge cost information contain a matrix of strike prices and a matrix of insurance prices corresponding to the strike prices.

13. The computer-readable medium of claim 12, wherein each of the insurance prices represents a hedge cost per gallon for insuring against a risk of the customer depleting a virtual gas tank of the fuel when retail prices of the fuel exceed the customer's lock price.

14. The computer-readable medium of claim 13, wherein the program instructions are further executable by the processor to perform warehousing and managing the risk.

15. The computer-readable medium of claim 12, wherein the matrix of strike prices contains a plurality of parameters including strike prices for fuel grade per gallon, sensitivities, locations and duration.

16. The computer-readable medium of claim 15, wherein the program instructions are further executable by the processor to determine an amount of the insurance prices to be passed on to the customer.

17. A system comprising:
a processor;
a computer-readable medium carrying program instructions executable by the processor to perform:
generating hedge cost information as input to a revenue model, wherein the hedge cost information includes costs associated with hedging a commodity on a wholesale basis and wherein the revenue model specifies one or more revenue sources;
determining whether to pass none, some, or all of the costs to a customer, wherein the customer is an individual user or a commercial entity; and
aggregating a total net revenue per unit of the commodity from the one or more revenue sources.

18. The system of claim 17, wherein the hedge cost information contain a matrix of strike prices and a matrix of insurance prices corresponding to the strike prices.

19. The system of claim 18, wherein the commodity is fuel, wherein each of the insurance prices represents a hedge cost per gallon for insuring against a risk of the customer depleting a virtual tank of the fuel when retail prices of the fuel exceed the customer's lock price.

20. The system of claim 18, wherein the matrix of strike prices contains a plurality of parameters including strike prices for fuel grade per gallon, sensitivities, location, and duration.
